(19) United States
(12) Patent Application Publication
(10) Pub. No.: US 2020/0044406 A1
(43) Pub. Date: Feb. 6, 2020

(54) TERAHERTZ WAVE PULSE AMPLITUDE MODULATION SIGNAL AND OPTICAL PULSE AMPLITUDE MODULATION SIGNAL CONVERSION AMPLIFIER

(71) Applicant: Shenzhen University, Shenzhen, Guangdong (CN)

(72) Inventors: Zhengbiao Ouyang, Shenzhen, Guangdong (CN); Zhiliang Chen, Shenzhen, Guangdong (CN)

(21) Appl. No.: 16/485,113

(22) PCT Filed: Nov. 21, 2016
(86) PCT No.: PCT/CN2016/106688

§ 371 Date: Aug. 9, 2019

Related U.S. Application Data
(63) Continuation of application No. PCT/CN2016/106688, filed on Nov. 21, 2016.

(30) Foreign Application Priority Data
Feb. 15, 2016 (CN) 201610085847.3

(51) Int. Cl. H01S 1/00

(52) U.S. Cl. CPC H01S 1/00

(57) ABSTRACT

A terahertz wave pulse wave amplitude modulation signal and an optical pulse amplitude modulation signal conversion amplifier includes a rectangular cavity, an absorption cavity, a metal block, a first waveguide, a second waveguide, three metal films, a terahertz pulse wave and a reference light; the rectangular cavity is located at the terahertz pulse wave input port, an incident port of the terahertz pulse wave is located at an upper port of the absorption cavity, and the absorption cavity is connected with a first waveguide; the metal block is disposed within the first waveguide, and is movable; the first waveguide is connected with a second waveguide; and an output power of the reference light is in correspondence with a power of an input terahertz pulse wave.

### CROSS-REFERENCE TO RELATED APPLICATIONS

This application is a Continuation of Application No. PCT/CN2016/106688, filed on Nov. 21, 2016, and claims priority to Chinese Patent Application No. 201610085847.3, filed on Feb. 15, 2016. The content of the aforementioned applications are hereby incorporated by reference in their entireties.

### TECHNICAL FIELD

The present disclosure is related to a surface plasmon polariton terahertz wave pulse amplitude modulation signal direct-rotation optical pulse amplitude modulation conversion amplifier based on a metal-insulator-metal structure.

### BACKGROUND

In recent years, great progress have been made in the study of various bands in the electromagnetic spectrum. However, in the terahertz band (0.1 THz to 10 THz), research is still limited. Compared with the current wireless communications, the terahertz band contains more abundant and wider spectrum resources, which makes it have great potential and broad application prospects in the future of broadband wireless communications. Amplitude modulation (AM) wave communication is a commonly used communication method. In the terahertz amplitude modulation communication system, the terahertz amplitude modulation demodulator is an essential device.

Progress has been made in the study of terahertz wave detectors such as thermal effect detectors, thermistor detectors, liquid-helium-cooled Si or Ge thermal radiation measuring instruments, superconductor frequency-mixing techniques, and hot electron radiation detector by using cooling mechanism through scattering of phonons and electrons. Frequency-domain terahertz time-domain spectroscopy, which uses frequencies based on coherent electromagnetic pulses between far-infrared and microwaves as probing sources, and directly records amplitude time waveforms of terahertz radiation fields using photoconductive sampling or free-space electro-optic sampling, can measure the amplitude of the terahertz way e and also obtain phase information. Although these technologies have their own merits, they are all too large in size, and their working environment is very demanding. The resulting signals are very weak and require very high amplification-factor amplifiers. Therefore, they are expensive and inconvenient for practical applications. This makes the terahertz amplitude modulation demodulator built on the basis of the traditional terahertz wave detectors bulky and costly, which is not conducive to practical application.

The waveguide based on surface plasmon polariton (SPP) is break through the diffraction limit and realize optical information processing and transmission on the nanometer scale. Surface plasmon polaritons are surface electromagnetic waves that propagate on the surface of a metal when an electromagnetic wave is incident on the interface between the metal and a medium. According to the nature of the surface plasmon polaritons (SPPs), many devices based on simple plasmon polariton (SPP) structures have been proposed, such as filters, circulators, logic gates, and optical switches. These devices are relatively simple in structure and very convenient for optical circuit integration.

### SUMMARY

The purpose of the present disclosure is to overcome the deficiencies of the prior art and provide a conveniently integrated terahertz wave pulse amplitude modulation signal directly to optical pulse amplitude modulation signal conversion amplifier based on the surface plasmon polariton waveguide.

In order to solve the above-mentioned technical problems, the present disclosure adopts the following technical solutions:

A terahertz wave pulse amplitude modulation signal to an optical pulse amplitude modulation signal conversion amplifier of the present disclosure includes a rectangular cavity, an absorption cavity, a metal block, two waveguides, three metal films, a terahertz pulse wave and a reference light; the rectangular cavity is located at the terahertz pulse wave input port, an incident port of the terahertz pulse wave is located at an upper port of the absorption cavity, and the absorption cavity is connected with a first waveguide; the metal block is disposed within the first waveguide, and is movable; the first waveguide is connected with a second waveguide; and an output light power from the reference light is in correspondence with a power of an input terahertz pulse wave.

Inside the rectangular cavity is a high-transmittance material.

Inside the rectangular cavity is silicon (Si), germanium, or gallium arsenide.

Inside the absorption cavity is a high thermal-expansion-coefficient material.

Inside the absorption cavity is ethanol or mercury.

A cross-section shape of the absorption cavity is a circle, a polygon, or an ellipse.

The metal block is silver.

The first waveguide and the second waveguide are waveguides of a metal-insulator-metal (MIM) structure.

A medium in the first waveguide is air.

The terahertz pulse wave is a terahertz wave carried a pulse-amplitude modulation signal.

The reference light is a laser light or a coherent light.

The advantages of the present disclosure is that, the modulated signal in the terahertz wave is detected by using a conventional optical detector, and the integrated terahertz pulse amplitude modulated signal based on the surface plasmon polariton waveguide is directly converted into an optical pulse amplitude modulation signal, which greatly reduces the cost of the demodulation device of the terahertz pulse amplitude modulation signal and has wide application value. Because the cost of the optical signal detector is much lower than the cost of the terahertz signal detector, the manufacturing cost of the system is greatly reduced, and the modulation signal is greatly amplified in the conversion process, and no additional signal amplifier is required to amplify the detection signal, further reducing the system production costs.

These and other objects and advantages of the present disclosure will become readily apparent to those skilled in the art upon reading the following detailed description and claims and by referring to the accompanying drawings.

DETAILEDDESCRIPTION OF THE DRAWINGS

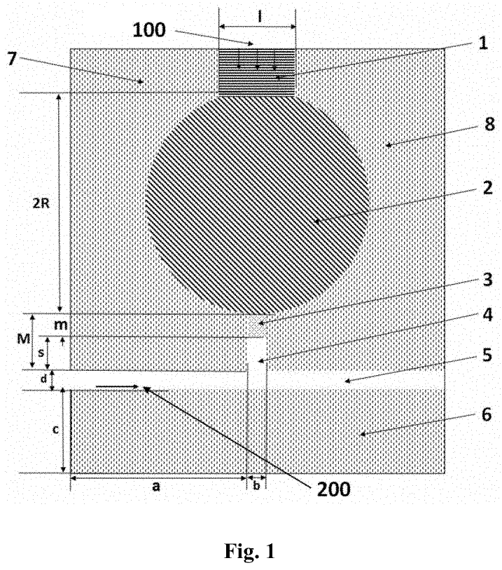

FIG. 1 shows a two-dimensional structural schematic diagram of a terahertz wave pulse amplitude modulation signal to an optical pulse amplitude modulation signal conversion amplifier in embodiment 1.

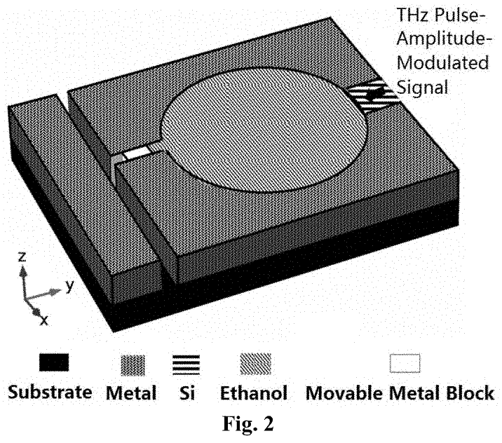

FIG. 2 shows a schematic view of the three-dimensional structure shown in FIG. 1.

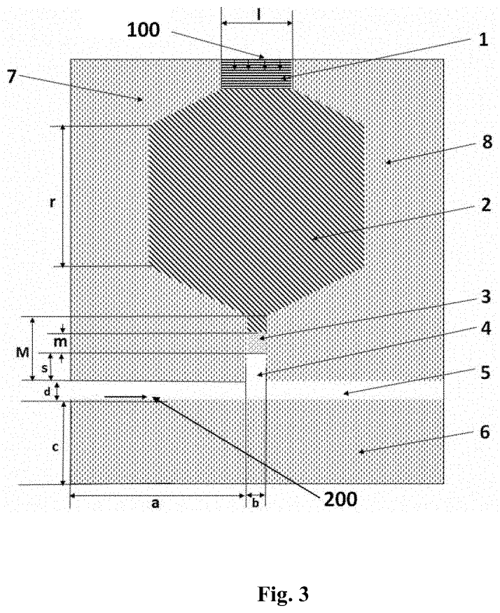

FIG. 3 shows a two-dimensional structural schematic diagram of the terahertz wave pulse amplitude modulation signal to the optical pulse amplitude modulation signal conversion amplifier in embodiment 2.

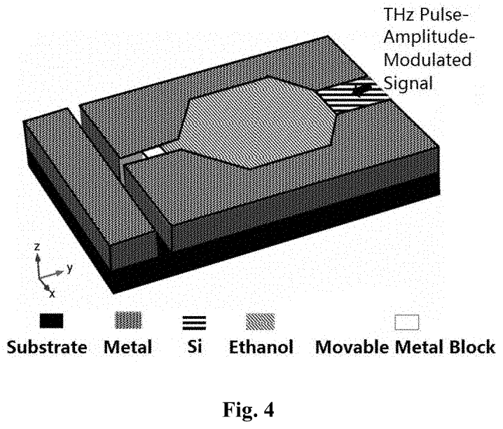

FIG. 4 shows a schematic diagram of the three-dimensional structure shown in FIG. 3.

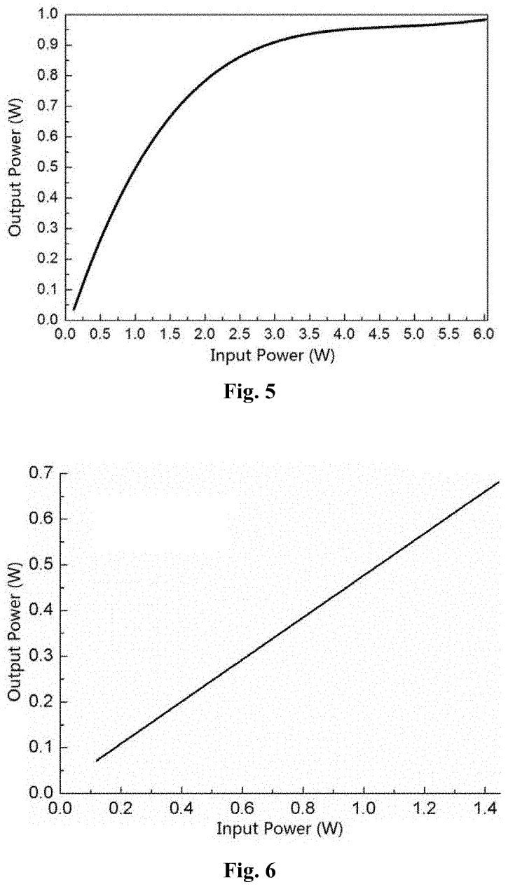

FIG. 5 shows a graph of the relationship between output light power and terahertz wave input power.

FIG. 6 shows a data fitting diagram of output light power.

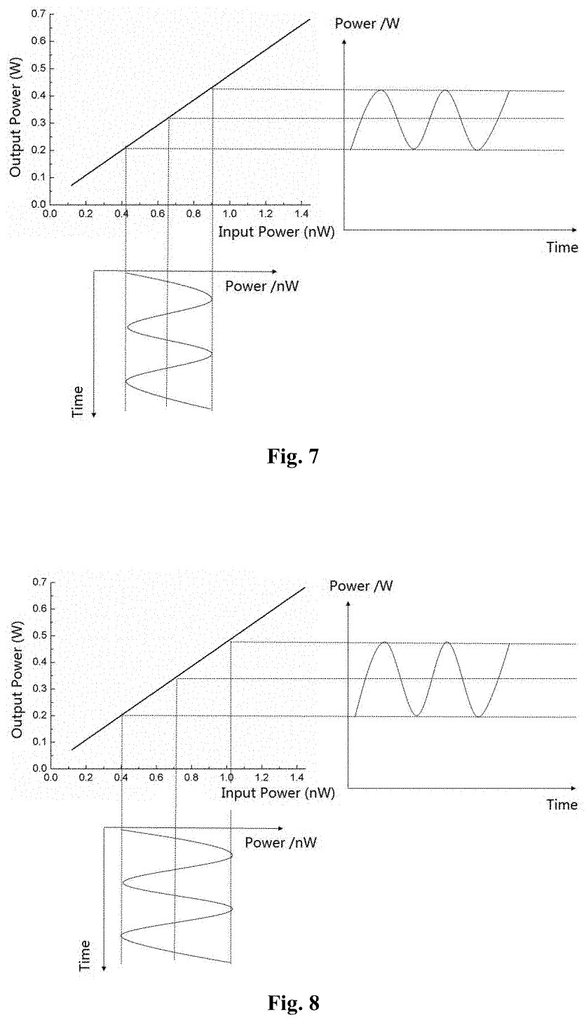

FIG. 7 shows a first output waveform conversion diagram of the terahertz pulse wave in embodiment 1.

FIG. 8 shows a second output waveform conversion diagram of the terahertz pulse wave in embodiment 1.

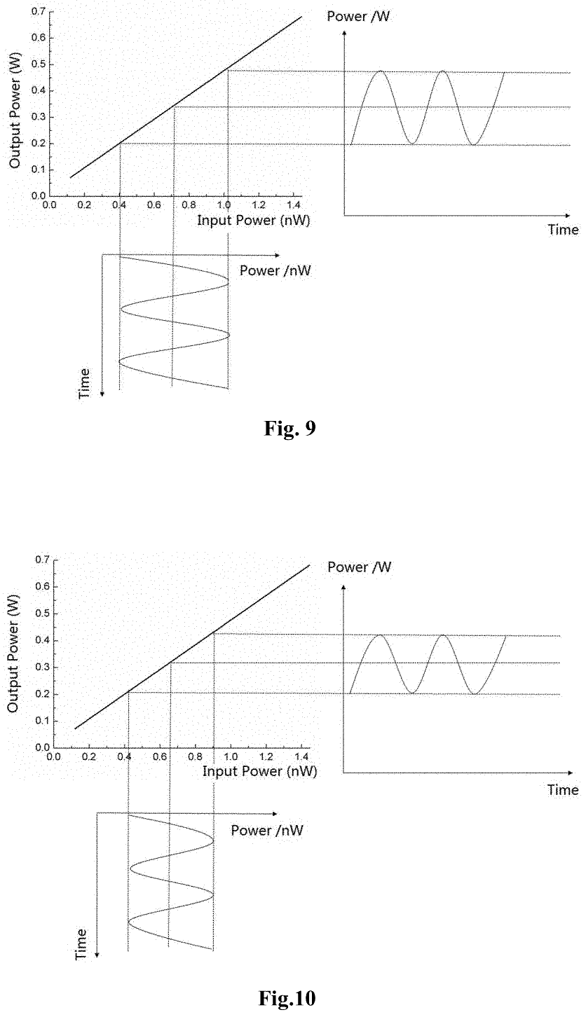

FIG. 9 shows a third output waveform conversion diagram of the terahertz pulse wave in embodiment 1.

FIG. 10 shows a first output waveform conversion diagram of the terahertz pulse wave in embodiment 2.

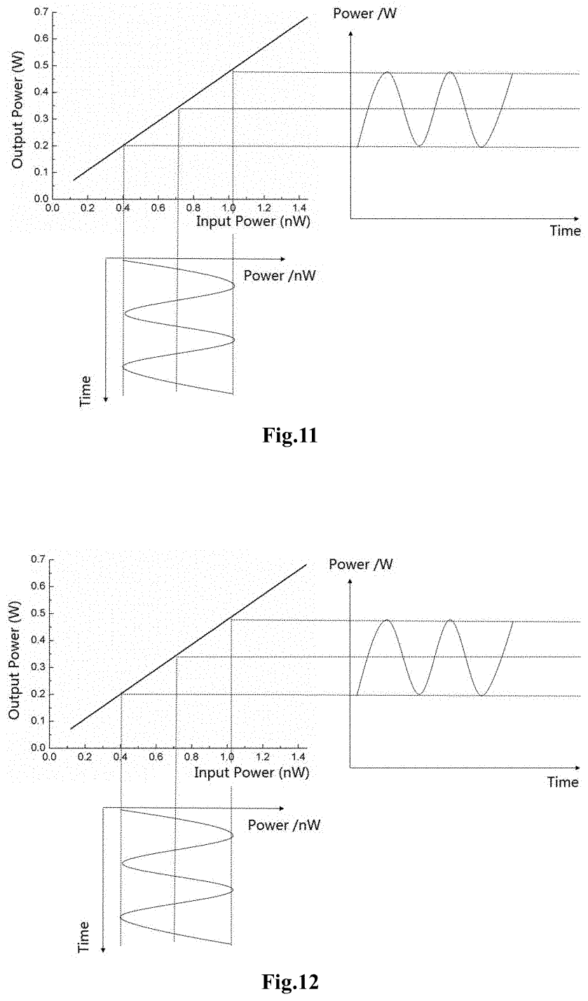

FIG. 11 shows a second output waveform conversion diagram of the terahertz pulse wave in embodiment 2.

FIG. 12 shows a third output waveform conversion diagram of the terahertz pulse wave in embodiment 2.

The present disclosure is more specifically described in the following paragraphs by reference to the drawings attached only by way of example.

### DETAILED DESCRIPTION

The terms a or an, as used herein, are defined as one or more than one. The term plurality, as used herein, is defined as two or more than two. The term another, as used herein, is defined as at least a second or more.

As shown in FIGS. 1 and 2 (the package medium above the structure is omitted in FIG. 2), the conversion amplifier of the present application includes a rectangular cavity 1, an absorption cavity (or a terahertz pulse wave absorption cavity) 2, a metal block (or a movable metal block) 3, and a first waveguide (or a vertical waveguide) 4, a second waveguide (or a horizontal waveguide) 5, metal film 6, 7 and 8, a terahertz pulse wave 100, and a reference light (or a horizontally-propagating reference light) 200, it propagates along the waveguide surface and forms the surface plasmon polariton (SPP); a rectangular cavity 1 located at the input port of the terahertz pulse wave, inside the rectangular cavity 1 is a high-transmittance material to control light, and is silicon (Si), germanium, or gallium arsenide; the width l of the rectangular cavity 1 is in the range of 150 to 500 nm; The terahertz pulse wave 100 of the signal itself is the modulation signal (i.e., input signal of the system); the center wavelength of the reference light 200 adopts 780 nm, and the spectrum bandwidth of the reference signal is 20 nm; the center wavelength of the terahertz pulse wave 100 adopts 3 μm; the terahertz pulse wave 100 is modulated by a pulse of period T and pulse width t; the period T is in the range of 0.1 μs to 3 ms, and the rang of the pulse width tis T/4 to T/2; the period T of the terahertz pulse wave 100 is 3 ms, and the pulse width t is 1 ms. The reference light 200 is a laser or a coherent light, the absorption chamber 2 is connected with the first waveguide 4, the absorption chamber 2 has a high thermal-expansion-coefficient, and is ethanol; the absorption cavity 2 adopts a circular cavity with a radius of R, and a cross-sectional area of 502655 nm²; the metal block 3 is disposed in the first waveguide 4, and is movable, and the length m of the metal block 3 is 80 to 150 nm, and m is 125 nm; the space length between the metal block 3 and the second waveguide 5 is s, and the range of s is 0 to 150 nm, and is determined by the position of the metal block 3; the metal block 3 is gold or silver, and uses silver; the first waveguide 4 is connected with the second waveguide 5; the first waveguide 4 and the second waveguide 5 are waveguides of a metal-insulator-metal (MIM) structure; metal films 6, 7 and 8 are gold, or silver, and are silver; the insulator is made of a non-conductive transparent material; the insulator is air, silicon dioxide, or silicon (Si); the first waveguide 4 is located at the upper port of the second waveguide 5; the width b of the first waveguide 4 is in the range of 30 to 60 nm, and the width b of the first waveguide 4 is 35 nm; the length M of the first waveguide 4 is greater than 200 nm, and the length M is 300 nm; the distance a from the left edge of the first waveguide 4 to the left edge of the metal film 6 is 400 nm, and the range of a is 350 to 450 nm; the width d of the second waveguide 5 is in the range of 30 to 100 nm, the width d is 50 nm, the medium in the second waveguide 5 is air; the distance from the lower edge of the second waveguide 5 to the edge of the metal film 6 is c, and c is greater than 150 nm.

The present disclosure heats the ethanol in the absorption cavity 2 by terahertz pulse wave 100, causing the ethanol to expand to push the metal block 3 to move toward the second waveguide 5 to change the length of the air segment in the first waveguide 4; since the metal block 3 moves downward due to temperature control, so the change of temperature affects the transmittance of the reference light 200. The metal block 3 is moved downward to change the space length between the metal block 3 and the second waveguide 5, and the transmittance of the reference light 200 changes accordingly. The output light power from the reference light 200 corresponds to the power of the input terahertz pulse wave 100, so that the reference light 200 is modulated into an optical pulse amplitude signal. In this way, the terahertz pulse amplitude modulation signal is completely converted into an optical pulse amplitude modulation signal, and the modulation signal is amplified. In accordance with the volt-ampere characteristic of the silicon photo-electric detector, the intensity of the obtained light pulse is converted into an electric signal, which is very convenient for processing. When the terahertz pulse wave 100 does not pass into the absorption cavity 2, under the action of the external atmospheric pressure, the metal block 3 will return to its initial position where the initial pressure balances, facilitating the arrival of the next pulse.

The specific heat capacity of the ethanol of the disclosure is C=2.4×10³ J/Kg·° C., the ethanol volume expansion coefficient of ethanol in the absorption cavity 2 is αₑₜₕₐₙₒₗ=1.1×10⁻³/° C., and the density of ethanol at room temperature (20° C.) is ρ=0.789 g/cm³. The coefficient of linear expansion of metal block 3 is α_{Ag}=19.5×10⁻⁶/° C., compared to the expansion of ethanol, the silver expansion of metal block 3 is negligible at the same temperature change.

The absorption of terahertz pulse wave 100 by the ethanol in the absorption cavity 2 follows Beer-lambert's law, and the absorption coefficient is defined as follows: a monochromatic laser light having an intensity of I₀ and a frequency of μ passes through the absorption medium of length l, after exiting the light intensity is I:

I=I₀e^{-κl} (1)

Then κ is defined as the absorption coefficient. The formula shows that the absorption of terahertz pulse wave 100 energy by ethanol solution is related to the length of light path in the ethanol medium. In order to make the energy of the terahertz pulse wave 100 absorbed by ethanol as large as possible, the length of the terahertz pulse wave 100 light path must be increased. The irradiation distance within the ethanol finally determines the incident port of the terahertz pulse wave 100 being at the upper port of the absorption cavity 2. When the terahertz pulse wave 100 is incident on the ethanol region, the ethanol absorbs the energy of the terahertz pulse wave 100, the temperature of ethanol rises and the volume of ethanol becomes larger, and then the metal block 3 moves to change the transmittance of the reference light 200. Finally, the terahertz pulse 100 amplitude modulation signal is converted into the light pulse amplitude modulation signal.

As shown in FIGS. 3 and 4 (the package medium above the structure is omitted), the conversion amplifier of the present disclosure includes a rectangular cavity 1, an absorption cavity (or a terahertz pulse wave absorption cavity) 2, a metal block (or a movable metal block) 3, and a first waveguide (or a vertical waveguide) 4. a second waveguide (or a horizontal waveguide) 5, metal films 6, 7 and 8, a terahertz pulse wave 100, and a horizontally-propagating reference light (or a reference light) 200, it propagates along the waveguide surface and forms the surface plasmon polaritons (SPP); a rectangular cavity 1 located at the input port of the terahertz pulse wave 100, inside the rectangular cavity 1 is a high-transmittance material to control light, and is silicon (Si), germanium, or gallium arsenide; the width l of the rectangular cavity 1 is in the range of 150 to 500 nm; The terahertz pulse wave 100 of the signal itself is the modulation signal (i.e., input signal of the system); the center wavelength of the reference light 200 adopts 780 nm, and the spectrum bandwidth of the reference signal is 20 nm; the center wavelength of the terahertz pulse wave 100 adopts 3 μm; the terahertz pulse wave 100 is modulated by a pulse of period T and pulse width t; the period Tis in the range of 0.1 μs to 3 ms, and the rang of the pulse width tis T/4 to T/2; the period T of the terahertz pulse wave is 3 ms, and the pulse width t is 1 ms. The reference light 200 is a laser or a coherent light, the absorption chamber 2 is connected with the first waveguide 4, the absorption chamber 2 has a high thermal-expansion-coefficient, and is ethanol; the absorption cavity 2 is a hexagonal cavity with a side length of r, and the cross-sectional area of 502655 nm²; the metal block 3 is disposed in the first waveguide 4, and is movable, the length m of the metal block 3 is 80 to 150 nm, and m is 125 nm; the space length between the metal block 3 and the second waveguide 5 is s, and the range of s is 0 to 150 nm, and is determined by the position of the metal block 3; the metal block 3 is gold, or silver, and uses silver; the first waveguide 4 is connected with the second waveguide 5; the first waveguide 4 and the second waveguide 5 are waveguides of a metal-insulator-metal (MIM) structure; the metal films 6, 7 and 8 are gold, or silver, and are silver; the insulator is made of a non-conductive transparent material; the insulator is air, silicon dioxide, or silicon; the first waveguide 4 is located at the upper port of the second waveguide 5; the width b of the first waveguide 4 is in the range of 30 to 60 nm, and the width b of the first waveguide 4 is 35 nm; the length M of the first waveguide 4 is greater than 200 nm, and the length M is 300 nm; the distance a from the left edge of the first waveguide 4 to the left edge of the metal film 6 is 400 nm, and the range of a is 350 to 450 nm; the width d of the second waveguide 5 is in the range of 30 to 100 nm, and the width d is 50 nm, and the medium in the second waveguide 5 is air; the distance from the lower edge of the second waveguide 5 to the edge of the metal film 6 is c, and c is greater than 150 nm.

The present disclosure heats the ethanol in the absorption cavity 2 by terahertz pulse wave 100, causing the ethanol to expand to push the metal block 3 to move toward the second waveguide 5 to change the length of the air segment in the first waveguide 4; since the metal block 3 moves downward due to temperature control, so the change of temperature affects the change of the transmittance of the reference light 200. The metal block 3 is moved downward to change the space length between the metal block 3 and the second waveguide 5, and the transmittance of the reference light 200 changes accordingly. The output light power from the reference light 200 corresponds to the power of the input terahertz pulse wave 100, so that the reference light 200 is modulated into an optical pulse amplitude signal. In this way, the terahertz pulse amplitude modulation signal is completely converted into an optical pulse amplitude modulation signal, and the modulation signal is amplified. In accordance with the volt-ampere characteristic of the silicon photo-electric detector, the intensity of the obtained light pulse is converted into an electric signal, which is very convenient for processing. When the terahertz wave does not pass into the absorption cavity 2, under the action of the external atmospheric pressure, the metal block 3 will return to the position where the initial pressure balances, facilitating the arrival of the next pulse.

As shown in FIG. 5, the time that the terahertz pulse wave 100 is incident into the absorption cavity 2 is equal to the pulse width t of the terahertz pulse, and is 1 ms. The terahertz pulse wave 100 heating time of the substance in the absorption cavity is 1 ms. For the circular cavity and the hexagonal cavity, the terahertz pulse wave 100 is reflected multiple times within it, so the absorption of terahertz pulse wave by the ethanol is regarded to be completely absorbed. In accordance with the parameters of the ethanol and the parameters of the structure, the relationship between the output light power from the reference light 200 and the input power of the terahertz pulse wave 100 is simulated and calculated, in which the power of the input signal laser is 1 W.

As shown in FIG. 6, for the input power of terahertz pulse wave 100 is 0.1 nW to 1.45 nW, the input and output have basically linear relation, which is a data fitting diagram. The modulation factor of the modulation converter, also called as magnification factor, is defined as follows:

$$Δ = \frac{Δ {P}_{out}}{Δ {P}_{i n}} \qquad ( 2 )$$

From the data and graph, and then in accordance with formula 2 is converted to a magnification factor of 0.4575×10⁹ times. In this way, the terahertz pulse amplitude signal is completely converted into an optical pulse amplitude signal, which is convenient for light detection. According to the volt-ampere characteristic of the silicon photo-electric detector, the intensity of the obtained light pulse is converted into an electric signal.

In at least one embodiment 1, the incident terahertz pulse amplitude modulation signal has a strength of 0.5 nW. Using the structures of FIGS. 1 and 2, the output light power from the reference light 200 in this case is 0.25 W (corresponding to a magnification factor of 0.5×10⁹) by two-dimensional (2D) numerical simulation, as shown in FIG. 7.

In at least one embodiment 2, the intensity of the incoming terahertz pulse amplitude modulation signal is 1 nW. Using the structures of FIGS. 1 and 2, the output light power from the reference light 200 in this case is 0.47 W (corresponding to a magnification factor of 0.47×10⁹) by 2D numerical simulation, as shown in FIG. 8.

In at least one embodiment 3, the incident terahertz pulse amplitude modulation signal intensity is 1.2 nW. Using the structures of FIGS. 1 and 2, the output light power from the reference light 200 in this case is 0.57 W (corresponding to a magnification factor of 0.475×10⁹) by 2D numerical simulation, as shown in FIG. 9.

In at least one embodiment 4, the incident terahertz pulse amplitude modulation signal has a strength of 0.5 nW. Using the structures of FIGS. 3 and 4, the output light power from the reference light 200 in the case is 0.25 W (corresponding to a magnification factor of 0.5×10⁹) by 2D numerical simulation, as shown in FIG. 10.

In at least one embodiment 5, the intensity of the incoming terahertz pulse amplitude modulation signal is 1 nW. Using the structures of FIGS. 3 and 4, the output light power from the reference light 200 in the case is 0.47 W (corresponding to a magnification factor of 0.47×10⁹) by 2D numerical simulation, as shown in FIG. 11.

In at least one embodiment 6, the incident terahertz pulse amplitude modulation signal intensity is 1.2 nW. Using the structures of FIGS. 3 and 4, the output light power from the reference light 200 in the case is 0.57 W (corresponding to a magnification factor of 0.475×10⁹) by 2D numerical simulation, as shown in FIG. 12.

While the disclosure has been described in terms of various specific embodiments, those skilled in the art will recognize that the disclosure is practiced with modification within the spirit and scope of the claims.

What is claimed is:

1. A terahertz wave pulse amplitude modulation signal to an optical pulse amplitude modulation signal conversion amplifier, comprising:
a rectangular cavity, an absorption cavity, a metal block, two waveguides, three metal films, a terahertz pulse wave and a reference light; the rectangular cavity is located at the terahertz pulse wave input port, an incident port of the terahertz pulse wave is located at an upper port of the absorption cavity, and the absorption cavity is connected with a first waveguide; the metal block is disposed within the first waveguide, and is movable; the first waveguide is connected with a second waveguide; and an output power from the reference light is in correspondence with a power of an input terahertz pulse wave.

2. The terahertz wave pulse amplitude modulation signal and the optical pulse amplitude modulation signal conversion amplifier of claim 1, wherein inside the rectangular cavity is a high-transmittance material.

3. The terahertz wave pulse amplitude modulation signal and the optical pulse amplitude modulation signal conversion amplifier of claim 1, wherein inside the rectangular cavity is silicon (Si), germanium, or gallium arsenide.

4. The terahertz wave pulse amplitude modulation signal and the optical pulse amplitude modulation signal conversion amplifier of claim 1, wherein inside the absorption cavity is a high thermal-expansion-coefficient material.

5. The terahertz wave pulse amplitude modulation signal and the optical pulse amplitude modulation signal conversion amplifier of claim 1, wherein inside the absorption cavity is ethanol, or mercury.

6. The terahertz wave pulse amplitude modulation signal and the optical pulse amplitude modulation signal conversion amplifier of claim 1, wherein a cross-section shape of the absorption cavity is a circle, a polygon, or an ellipse.

7. The terahertz-wave pulse amplitude modulation signal and the optical pulse amplitude modulation signal conversion amplifier of claim 1, wherein the metal block is silver.

8. The terahertz wave pulse amplitude modulation signal and the optical pulse amplitude modulation signal conversion amplifier of claim 1, wherein the first waveguide and the second waveguide are waveguides of a metal-insulator-metal (MIM) structure.

9. The terahertz wave pulse amplitude modulation signal and the optical pulse amplitude modulation signal conversion amplifier of claim 1, wherein a medium in the first waveguide is air.

10. The terahertz wave pulse amplitude modulation signal and the optical pulse amplitude modulation signal conversion amplifier of claim 1, wherein the terahertz pulse wave is a terahertz pulse wave carried a pulse-amplitude modulation signal.

11. The terahertz wave pulse amplitude modulation signal and the optical pulse amplitude modulation signal conversion amplifier of claim 1, wherein the reference light is a laser light or a coherent light.
